(19) United States
(12) Patent Application Publication
(10) Pub. No.: US 2025/0045770 A1
(43) Pub. Date: Feb. 6, 2025

(54) MANAGING OWNERSHIP TRANSFERS FOR DATA PROCESSING SYSTEMS USING A VOUCHER MANAGEMENT SERVICE

(71) Applicant: Dell Products L.P., Round Rock, TX (US)

(72) Inventors: BRADLEY K. GOODMAN, Nashua, NH (US); JOSEPH CAISSE, Burlington, MA (US); JEROME A. KORTHALS, Round Rock, TX (US); JENNA TARTAGLINO, Needham, MA (US)

(21) Appl. No.: 18/362,909

(22) Filed: Jul. 31, 2023

(51) Int. Cl. G06Q 30/018; H04L 9/32

(52) U.S. Cl. CPC G06Q 30/018; H04L 9/3268

(57) ABSTRACT

Methods and systems for managing vouchers usable to onboard data processing systems are disclosed. To manage vouchers, a first entity may maintain a voucher for a data processing system using a voucher management service following sale of the data processing system to an intermediate entity. The first entity may obtain transaction data to record a log of all transactions involving the data processing system without providing the voucher to any intermediate entities. Upon sale of the data processing system by an intermediate entity to a final entity, the first entity may update the voucher to reflect ownership of the data processing system by the final entity and may initiate onboarding of the data processing system by the final entity.

### FIELD

Embodiments disclosed herein relate generally to managing vouchers usable to onboard data processing systems. More particularly, embodiments disclosed herein relate to systems and methods to manage vouchers during ownership transfers for data processing systems.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIG. 2A shows a diagram of a voucher management service generating a final voucher for a data processing system in accordance with an embodiment.

FIG. 2B shows a diagram of a voucher management service providing a trusted token to a customer device in accordance with an embodiment.

FIG. 2C shows a diagram of a voucher management service providing a voucher to an orchestrator in accordance with an embodiment.

FIG. 3 shows a flow diagram illustrating a method of managing a voucher usable to onboard a data processing system in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing vouchers usable to onboard data processing systems in a distributed environment. A voucher may include a cryptographically signed delegation of authority over a data processing system to an entity. The voucher may also include one or more certificates (e.g., a certificate chain), usable to maintain a record of transactions involving the data processing system.

The certificate chain my indicate, for example, a first transaction in which a first entity (e.g., a manufacturer) transfers authority over the data processing system to a second entity. However, following the first transaction, the second entity may choose to re-sell the data processing system. For example, the second entity may be an intermediate entity and the intermediate entity may re-sell the data processing system to a final entity (e.g., a customer).

To complete the first transaction, the first entity may transfer the voucher to the second entity (e.g., an intermediate entity). Following this voucher transfer, the first entity may no longer participate in subsequent voucher transfers and the second entity may be responsible for storing, updating, and securely transferring the voucher to the final entity. These processes may consume an undesirable quantity of computing resources and/or may apply an increased cognitive load to the second entity. Consequently, delays may occur in the sale of the data processing system to the final entity. In addition, unavailability of adequate resources may negatively impact security of the voucher.

For example, an intermediate entity may purchase a data processing system from a manufacturer (e.g., the first entity) and may sell the data processing system to a customer (e.g., the final entity). To do so, the intermediate entity may obtain a voucher for the data processing system from the manufacturer. The intermediate entity may maintain the voucher and may update a chain of certificates included in the voucher, the chain of certificates serving as a record of all transactions involving the data processing system. However, the intermediate entity may not have sufficient resources (e.g., computing resources, capacity to securely operate a system to manage vouchers, availability of workers, etc.) to perform the above-described processes.

To alleviate the resource expenditure required of intermediate entities during transfers of authority for data processing systems, vouchers may be generated, maintained, and transferred by the first entity throughout all subsequent transactions until authority over the data processing system is transferred to the final entity, thereby removing the intermediate entity's role in handling vouchers.

To do so, the first entity may generate a voucher for the data processing system and may transfer authority over the data processing system to an intermediate entity without transferring the voucher to the intermediate entity. The first entity may maintain a transaction log and may add an entry to the transaction log indicating a sale of the data processing system to the intermediate entity.

Upon sale of the data processing system by the intermediate entity to a final entity (e.g., a customer), the intermediate entity may provide the first entity with data indicating the sale of the data processing system. Upon receipt of the data, the first entity may update the transaction log. The first entity may update the voucher to obtain a final voucher for the data processing system. The final entity may subsequently participate (e.g., via one or more orchestrators) in an onboarding process during which the one or more orchestrators may contact the first entity to obtain a copy of the final voucher.

Thus, a first entity may manage a voucher for a data processing system during all intermediate transactions until authority over the data processing system is transferred to a final entity. As ownership of the data processing system may be passed between one or more intermediate entities before being transferred to the final entity (e.g., a customer), the intermediate entities may not be responsible for managing the voucher. Doing so may improve security of the voucher and may reduce potential delays and/or resource demands on the intermediate entities during ownership transfers for the data processing system.

In an embodiment, a method of managing vouchers is provided. The method may include: generating a voucher for a data processing system, the voucher indicating that a first entity has authority over the data processing system; obtaining first transaction data for the data processing system, the first transaction data indicating a change in authority over the data processing system from the first entity to a second entity; obtaining second transaction data for the data processing system, the second transaction data indicating a change in authority over the data processing system from the second entity to a third entity; updating the voucher using at least the first transaction data and the second transaction data to obtain a final voucher, the final voucher indicating a final entity with authority over the data processing system; and initiating onboarding of the data processing system by an orchestrator designated by the final entity using the final voucher.

The first transaction data may be obtained from a system managed by the first entity.

The first transaction data may indicate a sale of the data processing system to the second entity from the first entity.

The second transaction data may be obtained from a second system managed by the second entity.

Updating the voucher may include: generating a certificate comprising: a delegation statement; a public key for the final entity; and a signature generated with a private key for the first entity.

Updating the voucher may include: generating a first certificate comprising: a first delegation statement; a first public key for the second entity; and a first signature generated with a first private key for the first entity.

Updating the voucher may also include: obtaining a second certificate comprising: a second delegation statement; a second public key for the third entity; and a second signature generated with a second private key for the second entity.

Obtaining the second certificate may include: obtaining the second signature using a signing system designated by the second entity.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the method when the computer instructions are executed by the processor.

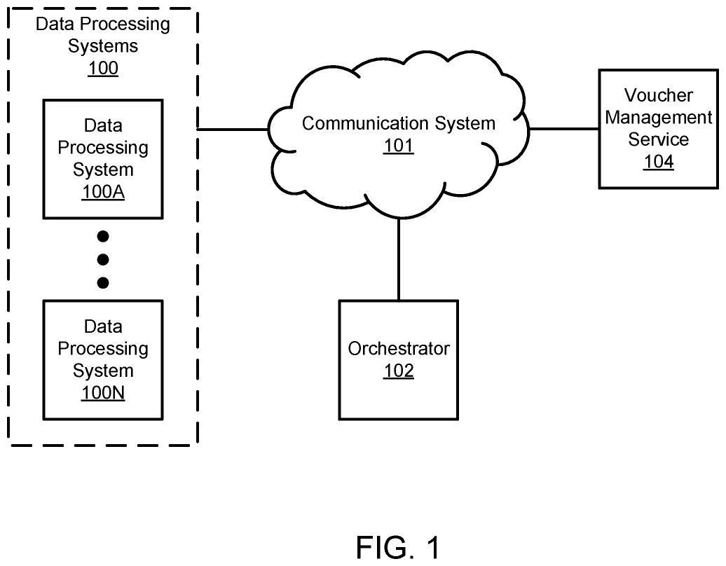

Turning to FIG. 1, a block diagram illustrating a system in accordance with an embodiment is shown. The system shown in FIG. 1 may provide computer-implemented services. The computer-implemented services may include any type and quantity of computer-implemented services. For example, the computer-implemented services may include voucher management services, data storage services, instant messaging services, database services, and/or any other type of service that may be implemented with a computing device.

To manage performance of the computer-implemented services, a distributed environment may include any number of data processing systems 100. A customer (a person/business that owns data processing systems 100) may have authority over data processing systems 100 and may utilize data processing systems 100 to facilitate performance of the computer-implemented services. The customer may obtain data processing systems of data processing systems 100 through a transaction involving a transfer of authority from another entity (e.g., a manufacturer of data processing systems 100, an intermediate entity re-selling data processing systems 100, etc.). Each transaction may involve a voucher transfer to the customer, the voucher indicating delegation of the authority to the customer.

If the customer (e.g., via operation of a data processing system similar to any of data processing systems 100) obtains a data processing system (e.g., data processing system 100A) directly from a first entity (e.g., a manufacturer of data processing systems 100A), the customer may obtain the voucher from voucher management service 104 operated by the first entity. However, if the customer obtains data processing system 100A from an intermediate entity (e.g., a re-seller), the customer may obtain the voucher from the intermediate entity without a direct interaction with the first entity.

However, securely storing and managing vouchers may consume an undesirable quantity of resources by the intermediate entity (e.g., computing resources to securely store and modify the vouchers, cognitive resources, time, etc.). The intermediate entity may be unable to allocate sufficient resources for performing a secure voucher transfer to the customer upon sale of data processing system 100A and, therefore, delays may occur in provision of computer-implemented services using the data processing system by the customer. In addition, management of the voucher by multiple entities (e.g., the first entity and the intermediate entity) throughout the ownership transfer process may increase vulnerability of the data processing system to security breaches.

In general, embodiments disclosed herein may provide methods, systems, and devices for managing vouchers for data processing systems sold to intermediate entities. To do so, the voucher may not be provided to the intermediate entity upon transfer of authority from the first entity to the intermediate entity. The first entity may generate a voucher for the data processing system (e.g., data processing system 100A) and may maintain the voucher until a sale of the data processing system to a final entity (e.g., the customer) occurs. The final entity may then request the voucher and the first entity may provide the voucher to the final entity.

Thus, vouchers usable to gain authority over data processing systems of data processing systems 100 may be managed throughout a sequence of transactions. The vouchers may be held by a first entity until a final transaction occurs through which authority over a data processing system is delegated to a final entity. By doing so, transfer of ownership and subsequent onboarding of data processing systems 100 may be streamlined and provision of the computer-implemented services may experience fewer interruptions (e.g., due to reduced down time during re-sale and onboarding of new data processing systems, etc.).

To onboard a data processing system of data processing systems 100 (e.g., data processing system 100A) the final entity may obtain a voucher from voucher management service 104.

To obtain the voucher, the final entity may present access credentials to voucher management service 104. The access credentials may include any authentication factor (e.g., a password, a pin, a biometric factor, etc.) usable to verify the identity and permissions of the customer.

However, in a distributed environment that includes a large number of data processing systems 100, the customer may not have adequate resources (e.g., hours, computing resource availability, etc.) to provide access credentials prior to each onboarding process for obtaining ownership vouchers for each to-be-onboarded device (e.g., data processing system). Therefore, delays in onboarding data processing systems 100 may lead to reductions in the availability and/or quality of the computer-implemented services to downstream consumers, onboarding of large numbers of devices may place unreasonable cognitive loads on entities responsible for managing onboarding, etc.

In general, embodiments disclosed herein may provide methods, systems, and devices for onboarding data processing systems without (and/or with reduced levels of) customer intervention. To do so, a trusted token (and/or any other indication of trust by the customer) may be used. The trusted token may be generated by voucher management service 104 and may be usable to delegate authority to another entity throughout the distributed environment (e.g., orchestrator 102) to manage onboarding of data processing systems 100.

To generate the trusted token, the customer (e.g., via a customer device that may be similar to any of data processing systems 100) may present the access credentials to voucher management service 104 and voucher management service may authenticate the access credentials. If the identity of the customer is verified using the access credentials, voucher management service 104 may generate the trusted token and may provide the trusted token to the customer. The customer may then provide the trusted token to orchestrator 102.

Consequently, whenever a new data processing system is added to the distributed environment, orchestrator 102 may provide a data package (e.g., including the trusted token) to voucher management service 104. Voucher management service 104 may recognize the trusted token and may provide a voucher to orchestrator 102. Orchestrator 102 may use the voucher to onboard (and otherwise manage) the new data processing system.

To provide the above noted functionality, the system may include data processing systems 100, orchestrator 102, and voucher management service 104. Each of these components is discussed below.

To provide the computer-implemented services, the system may include any number of data processing systems 100. For example, data processing systems 100 may include one data processing system (e.g., data processing system 100A) or multiple data processing systems (e.g., 100A-100N). Each data processing system of data processing systems 100 may include hardware and/or software components configured to provide the computer-implemented services. Data processing systems 100 may provide various computer-implemented services independently and/or cooperatively.

All, or a portion, of data processing systems 100 may provide (and/or participate in and/or support the) computer-implemented services to various computing devices operably connected to data processing systems 100. Different data processing systems may provide similar and/or different computer-implemented services.

For example, data processing system 100A may be a device (e.g., a manufacturer of data processing systems, an intermediate entity re-selling data processing systems, a customer purchasing data processing systems from the intermediate entity, etc.) used to interact with voucher management service 104. Additionally, data processing system 100N may be a new data processing system requiring onboarding to the distributed environment.

Data processing systems 100 may be manufactured and/or owned by a first entity (e.g., a manufacturer), and provided (e.g., sold) to other parties for use in computer-implemented services. When provided to the other entity, a voucher may be used to transfer control over a data processing system to the other entity. To facilitate the transfer, each of data processing systems 100 may contact a rendezvous system by default. The rendezvous system may direct data processing systems 100 to orchestrator 102 for management.

Voucher management service 104 may provide vouchers (e.g., including information usable to validate a root of trust and delegate authority over a data processing system to another entity) to entities with permissions to onboard and/or manage data processing systems 100. Voucher management service 104 may also manage a voucher for the data processing system throughout transactions involving intermediate entities (e.g., re-sellers, etc.).

To provide its functionality, voucher management service 104 may: (i) generate a voucher for a data processing system, the voucher indicating that a first entity has authority over the data processing system, (ii) obtaining first transaction data for the data processing system, the first transaction data indicating a change in authority over the data processing system from the first entity to a second entity, (iii) obtaining second transaction data for the data processing system, the second transaction data indicating a change in authority over the data processing system from the second entity to a third entity, (iv) updating the voucher using at least the first transaction data and the second transaction data to obtain a final voucher, the final voucher indicating a final entity with authority over the data processing system, and/or (v) initiating onboarding of the data processing system by an orchestrator designated by the final entity using the final ownership voucher.

Orchestrator 102 may onboard data processing systems 100 to provide desired computer-implemented services. To onboard data processing systems 100, orchestrator 102 may: (i) obtain the trusted token from the customer, (ii) provide the trusted token to voucher management service 104 upon identification of a data processing system that requires (and/or will require in the future, such as after being purchased by an operator of a deployment of data processing systems) onboarding, (iii) obtain the voucher in response to providing the trusted token to voucher management service 104, and/or (iv) may utilize the voucher to onboard and/or further manage the data processing system.

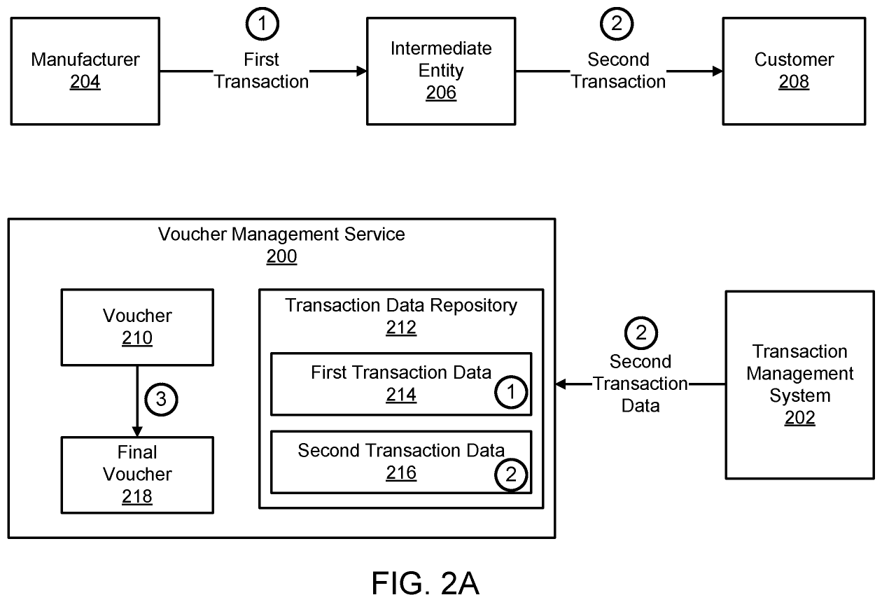

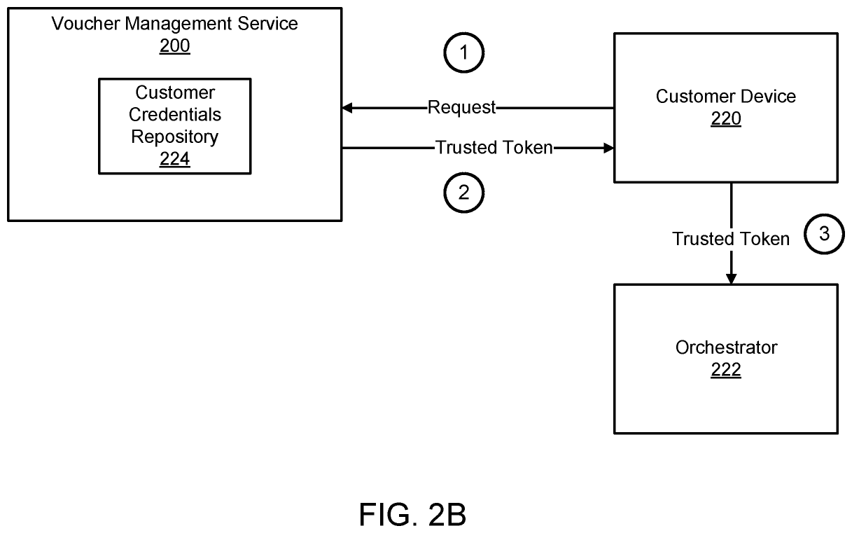

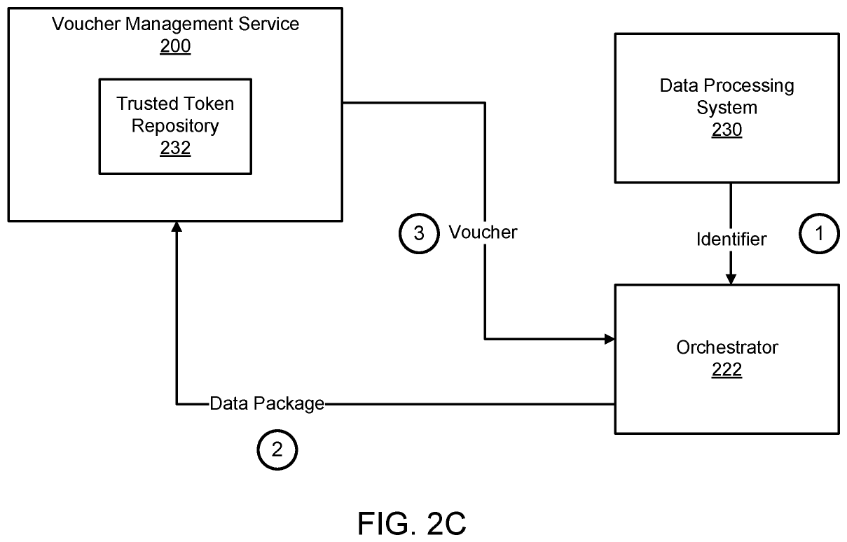

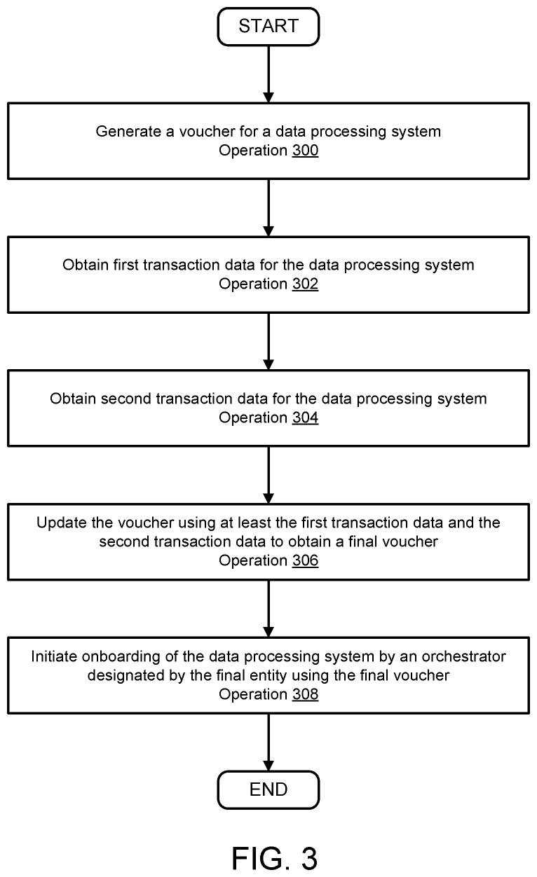

When performing their functionality, data processing systems 100, orchestrator 102, and/or voucher management service 104 may perform all, or a portion, of the methods and/or actions shown in FIGS. 2A-3.

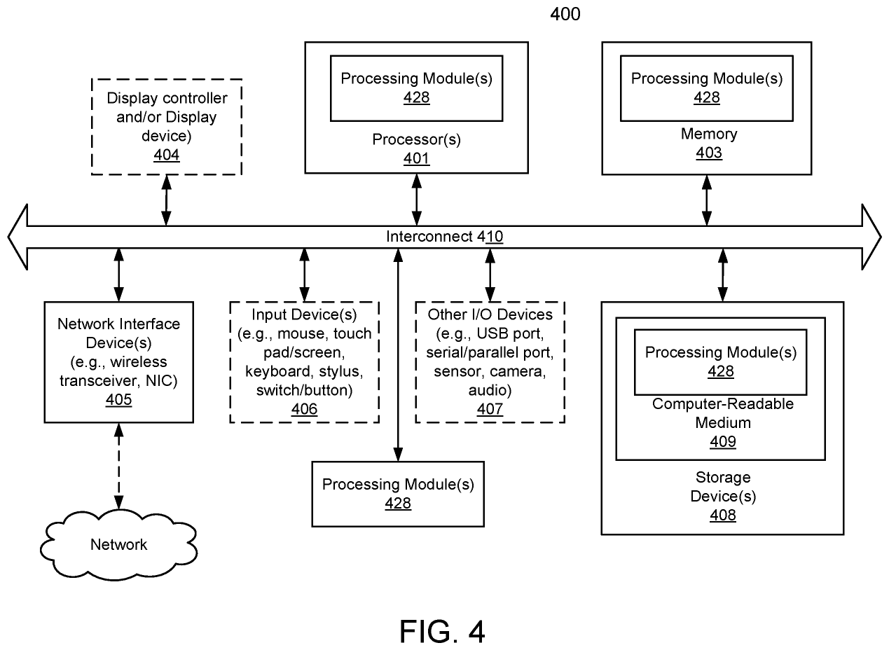

Data processing systems 100, orchestrator 102, and/or voucher management service 104 may be implemented using a computing device such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

In an embodiment, one or more of data processing systems 100, orchestrator 102, and/or voucher management service 104 are implemented using an internet of things (IoT) device, which may include a computing device. The IoT device may operate in accordance with a communication model and/or management model known to data processing systems 100, orchestrator 102, voucher management service 104, other data processing systems, and/or other devices.

Any of the components illustrated in FIG. 1 may be operably connected to each other (and/or components not illustrated) with a communication system 101. In an embodiment, communication system 101 may include one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as including a limited number of specific components, a system in accordance with an embodiment may include fewer, additional, and/or different components than those illustrated therein.

As discussed above, embodiments disclosed herein may facilitate management of vouchers during transactions involving data processing systems. FIGS. 2A-2C show diagrams illustrating various operations that may be performed to prepare for and/or to perform voucher transfers to customers.

Turning to FIG. 2A, a diagram of a voucher management service generating a final voucher for a data processing system in accordance with an embodiment is shown. In FIG. 2A, circles including numbers are used to indicate operations occurring at different points in time. For example, all operations described with reference to number one (1) may occur at a first point in time and all operations described with reference to the number two (2) may occur at a second point in time after the first point in time. While the operations are provided in an example temporal order (e.g., time point one before time point two), it will be appreciated that the operations may be performed in other orders from those illustrated and described herein.

Consider a scenario in which manufacturer 204 gains authority over a data processing system (not shown) via building the data processing system. At time point one (1) authority over the data processing system may be transferred to intermediate entity 206 via a first transaction as shown at the top of FIG. 2A. Intermediate entity 206 may be a re-seller and may subsequently perform a second transaction at time point two (2) to transfer authority over the data processing system to customer 208. Customer 208 may be an entity purchasing the data processing system to provide computer-implemented services.

Throughout the first transaction and the second transaction, manufacturer 204 may manage voucher 210 for the data processing system via voucher management service 200. Voucher management service 200 may be similar to voucher management service 104 shown in FIG. 1 and may be responsible for managing voucher 210 throughout the first transaction and the second transaction.

Specifically, prior to time point one (1), voucher management service 200 may generate voucher 210 for the data processing system, voucher 210 indicating that a first entity (e.g., manufacturer 204) has authority over the data processing system. Voucher 210 may include: (i) verification data usable to validate a root of trust for the data processing system, and (ii) at least one delegation of authority from the root of trust to the public key (e.g., associated with manufacturer 204).

The root of trust may be based on a designated private key and the verification data may include a corresponding public key for the designated private key. The designated private key may be any private key associated with manufacturer 204 (e.g., a string of numbers and/or letters known kept secret by manufacturer 204) usable for generating signatures. The corresponding public key for the designated private key may be any public key (e.g., a string of letters and/or numbers) associated with manufacturer 204 that is known publicly and is usable to verify signatures generated by the private key.

At time point one (1), the first transaction may occur. The first transaction may include, for example, a sale of the data processing system by manufacturer 204 to intermediate entity 206 (e.g., a re-seller of data processing systems, etc.). Voucher management service 200 may obtain first transaction data 214 as part of the first transaction and may store first transaction data 214 in transaction data repository 212.

First transaction data 214 may be obtained from a system managed by the first entity. In addition, first transaction data 214 may indicate a sale of the data processing system to the second entity (e.g., intermediate entity 206) from the first entity (e.g., manufacturer 204). For example, first transaction data 214 may include a sales record indicating the recipient of the data processing system (e.g., intermediate entity 206), the entity selling the data processing system (e.g., manufacturer 204), a timestamp associated with the first transaction, and/or any additional information (e.g., a public key associated with manufacturer 204, a public key associated with intermediate entity 206, etc.). The system managed by the first entity (e.g., manufacturer 204) may be a transaction management system operated by manufacturer 204 and/or any other entity associated with manufacturer 204 and responsible for recording information associated with each transaction completed by manufacturer 204.

First transaction data 214 may, therefore, indicate a change in authority over the data processing system from the first entity (e.g., manufacturer 204) to a second entity (e.g., intermediate entity 206). To indicate the change in authority, first transaction data 214 may include information regarding which permissions are delegated to intermediate entity 206 (e.g., permission to onboard, etc.).

At time point two (2) the second transaction may occur. The second transaction may include: (i) sale of the data processing system from intermediate entity 206 to another intermediate entity (not shown), and/or (ii) sale of the data processing system from intermediate entity 206 to customer 208 (e.g., a third entity). Customer 208 may not be an intermediate entity and may not intend to re-sell the data processing system.

The second transaction may be signified by voucher management service 200 obtaining second transaction data from transaction management system 202 and storing the second transaction data as second transaction data 216 in transaction data repository 212. Second transaction data 216 may indicate a change in authority over the data processing system from the second entity (e.g., intermediate entity 206) to a third entity (e.g., customer 208). In addition, the second transaction data may be obtained from a second system managed by the second entity. The second system may be, for example, transaction management system 202 managed by intermediate entity 206. Transaction management system 202 may be a data processing system responsible for obtaining records of transactions completed by intermediate entity 206 and providing transaction data to voucher management service 200 following completion of any of the transactions.

Similar to first transaction data 214, second transaction data 216 may include a sales record indicating the recipient of the data processing system (e.g., customer 208), the entity selling the data processing system (e.g., intermediate entity 206), a timestamp associated with the first transaction, and/or any additional information (e.g., a public key associated with intermediate entity 206, a public key associated with customer 208, etc.). Second transaction data 216 may include a list of permissions being granted to customer 208 (e.g., permission to onboard the data processing system, etc.).

In response to obtaining second transaction data 216, voucher management service 200 may update voucher 210 to obtain final voucher 218 at time point three (3). Final voucher 218 may indicate a final entity with authority over the data processing system. Final voucher 218 may include, for example, one or more certificates. Each certificate of the one or more certificates may include: (i) a delegation statement, (ii) a public key for an entity to which authority is being delegated, (iii) a signature generated with a private key for the entity delegating the authority, and/or (iv) other information.

In a first example, final voucher 218 may include a certificate, the certificate indicating a transfer of authority from the first entity (e.g., manufacturer 204) to the final entity (e.g., customer 208). In this first example, the certificate does not include information related to intermediate entity 206. The certificate may include: (i) a delegation statement, (ii) a public key for the final entity, (iii) a signature generated with a private key for the first entity, and/or (iv) other information.

The delegation statement may indicate which privileges are being delegated to the final entity. For example, the delegation of authority may indicate that all authority to manage, onboard, and/or otherwise modify the data processing system is being delegated to the final entity. The final entity may be, for example, a customer (e.g., customer 208) purchasing the data processing system to perform computer-implemented services using the data processing system.

The public key may be any public key (e.g., a string of letters, numbers, and/or other characters) associated with the final entity that is publicly available.

The signature generated using the private key (e.g., a private key kept secret by the first entity) may include cryptographic information generated using a payload (e.g., the delegation statement, the public key, etc.) and the designated private key. The cryptographic information may include a hash of the information and/or any other type of cryptographic information.

In a second example, final voucher 218 may include a first certificate and a second certificate, the first certificate representing the first transaction and the second certificate representing the second transaction.

The first certificate may include: (i) a first delegation statement, (ii) a first public key for the second entity (e.g., intermediate entity 206), (iii) a first signature generated with a first private key for the first entity (e.g., manufacturer 204), and/or (iv) other information.

The first delegation statement may indicate which privileges are being delegated to intermediate entity 206. For example, the first delegation statement may indicate that all authority to manage, onboard, and/or otherwise modify the data processing system is being delegated to intermediate entity 206.

The public key may be any public key (e.g., a string of letters, numbers, and/or other characters) associated with intermediate entity 206 that is publicly available.

The signature generated using the private key (e.g., a private key kept secret by manufacturer 204) may include cryptographic information generated using a payload (e.g., the delegation statement and the public key) and the designated private key. The cryptographic information may include a hash of the information and/or any other type of cryptographic information.

The second certificate may include: (i) a second delegation statement, (ii) a second public key for the third entity (e.g., customer 208), (iii) a second signature generated with a second private key for the second entity, and/or (iv) other information.

The second delegation statement may indicate which privileges are being delegated to the final entity. For example, the second delegation statement may indicate that all authority to manage, onboard, and/or otherwise modify the data processing system is being delegated to the final entity. The final entity may be, for example, a customer (e.g., customer 208) intending to use the data processing system to perform computer-implemented services.

The public key may be any public key (e.g., a string of letters, numbers, and/or other characters) associated with the final entity that is publicly available.

The signature generated using the private key (e.g., a private key kept secret by intermediate entity 206) may include cryptographic information generated using a payload (e.g., the delegation statement and the public key) and the designated private key. The cryptographic information may include a hash of the information and/or any other type of cryptographic information.

Final voucher 218 may be provided to customer 208 following the second transaction (not shown). Final voucher 218 may also be provided to an orchestrator (e.g., an entity with authority to onboard data processing systems owned by customer 208). For additional details regarding providing final voucher 218 to customer 208, refer to FIGS. 2B-2C.

Turning to FIG. 2B, a diagram of a voucher management service providing a trusted token to a customer device in accordance with an embodiment is shown. In FIG. 2B, circles including numbers are used to indicate operations occurring at different points in time. For example, all operations described with reference to number one (1) may occur at a first point in time and all operations described with reference to the number two (2) may occur at a second point in time after the first point in time. While the operations are provided in an example temporal order (e.g., time point one before time point two), it will be appreciated that the operations may be performed in other orders from those illustrated and described herein.

At time point one (1), customer device 220 may provide a request to voucher management service 200. Customer device 220 may be similar to any of data processing systems 100 shown in FIG. 1 and may be operated by a customer with authority over data processing systems throughout a distributed environment (e.g., which may have been purchased from another entity). The request may include: (i) access credentials for the customer, (ii) credentials for orchestrator 222 (e.g., similar to orchestrator 102 shown in FIG. 1), and/or (iii) other information usable to establish authority of the user for management of the data processing system and/or manage onboarding for the data processing system.

The access credentials for the customer may include any identifying information usable to authenticate the identity of the customer. For example, the access credentials may include a password, pin, biometric factor (e.g., fingerprint, etc.), and/or other information.

The credentials for orchestrator 222 may include any identifier (e.g., an internet protocol (IP) address, a globally unique identifier, etc.) for orchestrator 222. The credentials for orchestrator 222 may be usable by voucher management service 200 to identify an entity throughout the distributed environment. In FIG. 2B, the credentials for orchestrator 222 may indicate to which device customer device 220 delegates authority for device onboarding/management purposes.

Voucher management service 200 may obtain the request and compare the access credentials included in the request to corresponding information stored in customer credentials repository 224. Customer credentials repository 224 may include, for example, hashed passwords associated with different users and/or other types of information usable to authenticate the credentials in the request. For example, upon receipt of the request, voucher management service 200 may generate a hash of the password included in the request and may compare the hash of the password from the request to a corresponding hashed password associated with the customer (e.g., which may be part of an account with the entity from which data processing systems may be obtained, such as a manufacturer, reseller, etc.). If the hash of the password from the request matches the hashed password stored in customer credentials repository 224, voucher management service 200 may trust that the request originated from the customer operating customer device 220.

At time point two (2), voucher management service 200 may provide a trusted token to customer device 220 in response to the request. Voucher management service 200 may generate the trusted token upon verification of the access credentials and/or other information included in the request. The trusted token may include: (i) a payload including the credentials for orchestrator 222 (provided in the request), and a trusted signature (e.g., cryptographic information generated using a trusted private key (or other type of secret, such as a symmetric key) maintained by voucher management service 200). The trusted signature may, for example, allow voucher management service 200 to determine whether an orchestrator that has the trusted token is an orchestrator for which the trusted token was generated, whether the credentials of orchestrator 222 have been modified since the trusted token was generated, etc.

At time point three (3), customer device 220 may provide the trusted token to orchestrator 222. By providing the trusted token to orchestrator 222, orchestrator 222 may use the trusted token to indicate its status as an entity trusted by customer device 220 (e.g., and, therefore, the customer) to onboard and/or further manage data processing systems under the authority of the customer. Consequently, when orchestrator 222 provides the trusted token in the future, it may serve to authenticate orchestrator 222 with respect to obtaining vouchers managed by voucher management service 200.

Turning to FIG. 2C, a diagram of voucher management service 200 providing a voucher to orchestrator 222 in accordance with an embodiment is shown. In FIG. 2C, circles including numbers are used to indicate operations occurring at different points in time. For example, all operations described with reference to number one (1) may occur at a first point in time and all operations described with reference to the number two (2) may occur at a second point in time after the first point in time. While the operations are provided in temporal order (e.g., time point one before time point two), it will be appreciated that the operations may be performed in other orders from those illustrated and described herein.

Consider a scenario in which data processing system 230 is added (e.g., through purchase or other mechanism) to a highly distributed environment and requires onboarding (e.g., set up of access restrictions, installation of software, modification of settings, etc.) to participate in the provision of computer-implemented services. To onboard data processing system 230 without intervention by a customer with authority over data processing system 230, orchestrator 222 may obtain a voucher from voucher management service 200.

At time point one (1), data processing system 230 may provide an identifier to orchestrator 222. The identifier may include any information (e.g., an IP address, a data structure indicating ownership by the customer, a notification, etc.) usable to indicate that data processing system 230 is under authority of the customer and has been added to the distributed environment.

Upon receipt of the identifier and/or responsive to other types of events (e.g., such as at time of purchase and/or prior to data processing system 230 joining the distributed environment), orchestrator 222 may seek to obtain a voucher from voucher management service 200 to perform the onboarding process. At time point two (2), orchestrator 222 may provide a data package to voucher management service 200. The data package may include: (i) the trusted token (described in FIG. 2B), (ii) the credentials for the orchestrator (described in FIG. 2B), (iii) a public key associated with the orchestrator, and/or (iv) other information.

The public key for the orchestrator (e.g., orchestrator 222) may be a public key (e.g., a string of letters, numbers, other characters, etc.) associated with orchestrator 222 that is available publicly and is usable to verify signatures generated using a private key maintained by orchestrator 222 (e.g., orchestrator 222 may sign work orders for data processing system 230 using the private key).

Upon receipt of the data package, voucher management service 200 may verify that the trusted token matches the trusted token generated by voucher management service 200 (shown in FIG. 2B) using trusted token repository 232. If the trusted token has not been altered (and therefore indicates that orchestrator 222 is to be trusted for vouchers for data processing systems under authority of the user), voucher management service 200 may provide a voucher to orchestrator 222.

At time point three (3) voucher management service 200 may provide the voucher to orchestrator 222 to facilitate onboarding of data processing system 230 by orchestrator 222. The voucher may include: (i) verification data usable to validate a root of trust for the data processing system (e.g., data processing system 230), and (ii) at least one delegation of authority from the root of trust to the public key (e.g., associated with orchestrator 222).

The root of trust may be based on a designated private key and the verification data may include a corresponding public key for the designated private key. The designated private key may be any private key associated with another entity (e.g., a string of numbers and/or letters known kept secret by the other entity) usable for generating signatures. The other entity may be, for example, the manufacturer of data processing system 230. The corresponding public key for the designated private key may be any public key (e.g., a string of letters and/or numbers) associated with the manufacturer that is known publicly and is usable to verify signatures generated by the private key.

The at least one delegation of authority from the root of trust to the public key may include a certificate. The certificate may include: (i) a payload including an intermediate public key, (ii) a signature generated using the designated private key, and/or (iii) other information. The at least one delegation of authority may include a certificate chain. The certificate chain may establish cryptographically verifiable delegations of authority from the root of trust to orchestrator 222.

The payload may include a statement of delegation indicating which privileges are being delegated to the entity associated with the intermediate public key. For example, the payload may indicate that all authority to manage, onboard, and/or otherwise modify data processing system 230 is being delegated to an intermediate entity (not shown). The intermediate entity may be, for example, a client that is selling data processing system 230 to another client. The intermediate public key may be any public key (e.g., a string of letters, numbers, and/or other characters) associated with the intermediate entity that is publicly available and usable for to encrypt data intended to be decrypted by only the intermediate entity. The payload may include any number of such certificates that establish a cryptographically verifiable certificate chain between the root of trust and the public key associated with the designed private key (e.g., managed by orchestrator 222).

The signature generated using the designated private key (e.g., a private key kept secret by the manufacturer of data processing system 230) may include cryptographic information generated using the payload and the designated private key. The cryptographic information may include a hash of the information and/or any other type of cryptographic information.

The certificate may also include a second certificate. The second certificate may include: (i) a second payload including the public key for the orchestrator (e.g., orchestrator 222), (ii) a second signature generated using an intermediate private key corresponding to the intermediate public key, and/or (iii) other information.

The second payload may include a second statement of delegation indicating which privileges are being delegated to orchestrator 222. For example, the second payload may indicate that orchestrator 222 is being delegated authority to onboard data processing system 230.

The second signature generated using the intermediate private key may include cryptographic information generated using the payload and the intermediate private key (e.g., kept secret by the intermediate entity). The cryptographic information may include a hash of the information and/or any other type of cryptographic information.

Following obtaining the voucher, orchestrator 222 may proceed to perform onboarding operations and/or other actions to manage data processing system 230.

The onboarding operations may include, for example, contacting and providing a copy of the voucher to a rendezvous system (not shown). Data processing system 230 may contact the rendezvous system may default upon first power up. Data processing system 230 may be directed to orchestrator 222 by the rendezvous system, and may obtain a copy of the voucher from the rendezvous system or orchestrator 222. Consequently, when data processing system 230 contacts orchestrator 222, data processing system 230 may have access to a trusted key (e.g., from the voucher) usable to cryptographically verify authority of orchestrator 222 to invoke various functions of data processing system 230. For example, to prepare data processing system 230 to provide certain services, orchestrator 222 may generate workorders instructing data processing system 230 to install various pieces of software components, modify configurations of software and/or hardware components, and/or perform other actions.

In an embodiment, the one or more entities performing the operations shown in FIGS. 2A-2C are implemented using a processor adapted to execute computing code stored on a persistent storage that when executed by the processor performs the functionality of the system of FIG. 1 discussed throughout this application. The processor may be a hardware processor including circuitry such as, for example, a central processing unit, a processing core, or a microcontroller. The processor may be other types of hardware devices for processing information without departing from embodiments disclosed herein.

As discussed above, the components of FIG. 1 may perform various methods to manage vouchers. FIG. 3 illustrates methods that may be performed by the components of FIG. 1. In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method of managing a voucher usable to onboard a data processing system in accordance with an embodiment is shown. The method may be performed, for example, by a voucher management service, an orchestrator, a data processing system, and/or any other entity.

At operation 300, a voucher for a data processing system is generated. The voucher may indicate that a first entity has authority over the data processing system. Generating the voucher may include: (i) obtaining a public key associated with the first entity, (ii) encapsulating the public key (and/or other data including, for example, a delegation statement and a signature generated using a private key for the first entity) in a data structure, (iii) treating the data structure as the voucher, and/or (iv) other methods.

At operation 302, first transaction data for the data processing system is obtained. The first transaction data may indicate a change in authority over the data processing system from the first entity to a second entity. Obtaining the first transaction data may include: (i) reading the first transaction data from storage, (ii) receiving the first transaction data in the form of a transmission over a communication system (e.g., a message, a notification in an application on a device, etc.), and/or (iii) other methods.

At operation 304, second transaction data for the data processing system is obtained. The second transaction data may indicate a change in authority over the data processing system from the second entity to a third entity. Obtaining the second transaction data may include: (i) reading the second transaction data from storage, (ii) receiving the second transaction data in the form of a transmission over a communication system (e.g., a message, a notification in an application on a device, etc.), and/or (iii) other methods.

At operation 306, the voucher is updated using at least the first transaction data and the second transaction data to obtain a final voucher. The final voucher may indicate a final entity with authority over the data processing system.

In a first example, the final voucher may include one certificate indicating a change in ownership for the data processing system from the first entity to the final entity. By doing so, the second entity (e.g., an intermediate entity such as an entity re-selling the data processing system to the third entity) may not be included in the final voucher.

In the first example, updating the voucher may include: (i) generating a certificate, (ii) encapsulating the certificate in a data structure, (iii) treating the data structure as the voucher, and/or (iv) other methods. Updating the voucher may also include obtaining the certificate from another entity responsible for generating the certificate and encapsulating the certificate in the data structure.

Generating the certificate may include: (i) obtaining a delegation statement, (ii) obtaining a public key for the final entity, (ii) obtaining a signature generated with a private key for the first entity, and/or (iii) other methods.

Obtaining the delegation statement may include: (i) reading the delegation statement from storage, (ii) generating the delegation statement based on information obtained from the first entity, (iii) receiving the delegation statement from another entity, and/or (iv) other methods.

Obtaining the public key for the final entity may include: (i) reading the public key from storage, (ii) requesting the public key from another entity (e.g., the final entity) and receiving the public key as a transmission over a communication system in response to the request, and/or (iii) other methods.

Obtaining the signature may include: (i) providing at least a portion of the certificate to an entity (e.g., a signing system) associated with the first entity, (ii) requesting that the first entity cryptographically sign (e.g., using a private key kept secret by the first entity) the at least a portion of the certificate, and/or (iii) receiving a signed copy of the at least a portion of the certificate from the first entity.

In a second example, the final voucher may include a chain of certificates including any number of certificates. In this second example, each certificate of the chain of certificates may correspond to a transaction for the data processing system. For example, a first certificate may represent a first sale of the data processing system from a first entity to a second entity (e.g., an intermediate entity planning to re-sell the data processing system). Similarly, a second certificate may represent a second sale of the data processing system from the second entity to a third entity. If the third entity is a final entity (e.g., not another intermediate entity planning to re-sell the data processing system), the chain of certificates may end with the second certificate. If the third entity is not the final entity (e.g., the third entity is another intermediate entity), the certificate chain may include any number of additional certificates ending with a final certificate signifying the final sale of the data processing system to a final entity (e.g., a consumer).

In this second example, updating the voucher may include: (i) generating a first certificate, (ii) obtaining a second certificate, and/or (iii) other methods. Updating the voucher may include generating any number of additional certificates if additional transactions are recorded as transaction data by the first entity. In addition, updating the voucher may include encapsulating all certificates in a data structure as a chain of certificates following obtaining the certificates.

Generating the first certificate may include: (i) obtaining a first delegation statement, (ii) obtaining a first public key for the second entity, (ii) obtaining a first signature generated with a first private key for the first entity, and/or (iii) other methods.

Obtaining the first delegation statement may include: (i) reading the first delegation statement from storage, (ii) generating the first delegation statement based on information obtained from the first entity, (iii) receiving the first delegation statement from another entity, and/or (iv) other methods.

Obtaining the first public key for the second entity may include: (i) reading the first public key from storage, (ii) requesting the first public key from another entity (e.g., the second entity) and receiving the first public key as a transmission over a communication system in response to the request, and/or (iii) other methods.

Obtaining the first signature may include (i) providing at least a portion of the certificate to an entity (e.g., a signing system) associated with the first entity, (ii) requesting that the first entity cryptographically sign (e.g., using a private key kept secret by the first entity) the at least a portion of the certificate, and/or (iii) receiving a signed copy of the at least a portion of the certificate from the first entity.

Obtaining the second certificate may include: (i) obtaining a second delegation statement, (ii) obtaining a second public key for the third entity, (ii) obtaining a second signature generated with a second private key for the second entity using a signing system designated by the second entity, and/or (iii) other methods.

Obtaining the second delegation statement may include: (i) reading the second delegation statement from storage, (ii) generating the second delegation statement based on information obtained from the second entity, (iii) receiving the second delegation statement from another entity, and/or (iv) other methods.

Obtaining the second public key for the third entity may include: (i) reading the second public key from storage, (ii) requesting the second public key from another entity (e.g., the third entity) and receiving the second public key as a transmission over a communication system in response to the request, and/or (iii) other methods.

Obtaining the second signature may include (i) providing at least a portion of the certificate to an entity (e.g., a signing system) associated with the second entity, (ii) requesting that the second entity cryptographically sign (e.g., using a private key kept secret by the second entity) the at least a portion of the certificate, and/or (iii) receiving a signed copy of the at least a portion of the certificate from the second entity.

At operation 308, onboarding of the data processing system is initiated to an orchestrator designated by the final entity using the final voucher. Initiating onboarding of the data processing system may include: (i) obtaining a data package from the orchestrator, the data package indicating that the orchestrator is a trusted entity by the final entity (e.g., via inclusion of a trusted token, etc.), (ii) verifying the data package, (iii) if the data package is valid, providing the final voucher to the orchestrator, the final voucher being usable to onboard the data processing system, and/or (iv) other methods. Refer to FIGS. 2B-2C for additional details regarding onboarding data processing systems.

The method may end following operation 308.

Any of the components illustrated in FIGS. 1-3 may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method of managing vouchers, the method comprising:
generating a voucher for a data processing system, the voucher indicating that a first entity has authority over the data processing system;
obtaining first transaction data for the data processing system, the first transaction data indicating a change in authority over the data processing system from the first entity to a second entity;
obtaining second transaction data for the data processing system, the second transaction data indicating a change in authority over the data processing system from the second entity to a third entity;
updating the voucher using at least the first transaction data and the second transaction data to obtain a final voucher, the final voucher indicating a final entity with authority over the data processing system; and
initiating onboarding of the data processing system by an orchestrator designated by the final entity using the final voucher.

2. The method of claim 1, wherein the first transaction data is obtained from a system managed by the first entity.

3. The method of claim 2, wherein the first transaction data indicates a sale of the data processing system to the second entity from the first entity.

4. The method of claim 2, wherein the second transaction data is obtained from a second system managed by the second entity.

5. The method of claim 1, wherein updating the voucher comprises:
generating a certificate comprising:
a delegation statement;
a public key for the final entity; and
a signature generated with a private key for the first entity.

6. The method of claim 1, wherein updating the voucher comprises:
generating a first certificate comprising:
a first delegation statement;
a first public key for the second entity; and
a first signature generated with a first private key for the first entity.

7. The method of claim 6, wherein updating the voucher further comprises:
obtaining a second certificate comprising:
a second delegation statement;
a second public key for the third entity; and
a second signature generated with a second private key for the second entity.

8. The method of claim 7, wherein obtaining the second certificate comprises:
obtaining the second signature using a signing system designated by the second entity.

9. A non-transitory machine-readable medium having instructions stored therein, which when executed by a processor, cause the processor to perform operations for managing vouchers, the operations comprising:
generating a voucher for a data processing system, the voucher indicating that a first entity has authority over the data processing system;
obtaining first transaction data for the data processing system, the first transaction data indicating a change in authority over the data processing system from the first entity to a second entity;
obtaining second transaction data for the data processing system, the second transaction data indicating a change in authority over the data processing system from the second entity to a third entity;
updating the voucher using at least the first transaction data and the second transaction data to obtain a final voucher, the final voucher indicating a final entity with authority over the data processing system; and
initiating onboarding of the data processing system by an orchestrator designated by the final entity using the final voucher.

10. The non-transitory machine-readable medium of claim 9, wherein the first transaction data is obtained from a system managed by the first entity.

11. The non-transitory machine-readable medium of claim 10, wherein the first transaction data indicates a sale of the data processing system to the second entity from the first entity.

12. The non-transitory machine-readable medium of claim 10, wherein the second transaction data is obtained from a second system managed by the second entity.

13. The non-transitory machine-readable medium of claim 9, wherein updating the voucher comprises:
generating a certificate comprising:
a delegation statement;
a public key for the final entity; and
a signature generated with a private key for the first entity.

14. The non-transitory machine-readable medium of claim 9, wherein updating the voucher comprises:
generating a first certificate comprising:
a first delegation statement;
a first public key for the second entity; and
a first signature generated with a first private key for the first entity.

15. A data processing system, comprising:
a processor; and
a memory coupled to the processor to store instructions, which when executed by the processor, cause the processor to perform operations for managing vouchers, the operations comprising:
generating a voucher for a data processing system, the voucher indicating that a first entity has authority over the data processing system;
obtaining first transaction data for the data processing system, the first transaction data indicating a change in authority over the data processing system from the first entity to a second entity;
obtaining second transaction data for the data processing system, the second transaction data indicating a change in authority over the data processing system from the second entity to a third entity;
updating the voucher using at least the first transaction data and the second transaction data to obtain a final voucher, the final voucher indicating a final entity with authority over the data processing system; and
initiating onboarding of the data processing system by an orchestrator designated by the final entity using the final voucher.

16. The data processing system of claim 15, wherein the first transaction data is obtained from a system managed by the first entity.

17. The data processing system of claim 16, wherein the first transaction data indicates a sale of the data processing system to the second entity from the first entity.

18. The data processing system of claim 16, wherein the second transaction data is obtained from a second system managed by the second entity.

19. The data processing system of claim 15, wherein updating the voucher comprises:
generating a certificate comprising:
a delegation statement;
a public key for the final entity; and
a signature generated with a private key for the first entity.

20. The data processing system of claim 15, wherein updating the voucher comprises:
generating a first certificate comprising:
a first delegation statement;
a first public key for the second entity; and
a first signature generated with a first private key for the first entity.
